(19) United States
(12) Patent Application Publication
(10) Pub. No.: US 2021/0204346 A1
(43) Pub. Date: Jul. 1, 2021

(54) BEAM RECOVERY MECHANISM

(71) Applicant: IDAC Holdings, Inc., Wilmington, DE (US)

(72) Inventors: Chunxuan Ye, San Diego, CA (US); Fengjun Xi, San Diego, CA (US)

(73) Assignee: IDAC Holdings, Inc., Wilmington, DE (US)

(21) Appl. No.: 16/610,160

(22) PCT Filed: Apr. 30, 2018
(86) PCT No.: PCT/US2018/030188

§ 371 Date: Nov. 1, 2019

Related U.S. Application Data
(60) Provisional application No. 62/519,356, filed on Jun. 14, 2017.
(60) Provisional application No. 62/500,522, filed on May 3, 2017.

(51) Int. Cl. H04W 76/19; H04B 7/06; H04W 16/28

(52) U.S. Cl. CPC H04W 76/19; H04W 16/28; H04B 7/0695; H04B 7/0617

(57) ABSTRACT

Systems, methods, and instrumentalities are disclosed for receiving, at a wireless transmit/receive unit (WTRU), configuration information associated with beam failure recovery, detecting a beam failure and sending a first beam failure recovery request message on a first beam to a network entity, determining that a beam failure recovery response message has not been received using the configuration information associated with beam failure recovery, and if the WTRU is associated with a static rotation state or a low rotation state, performing a per-beam based recovery, and if the WTRU is associated with a high rotation state, performing an omni-directional beam recovery.

### CROSS REFERENCE TO RELATED APPLICATION

This application claims the benefit of U.S. Provisional Application No. 62/500,522, filed May 3, 2017, and U.S. Provisional Application No. 62/519,356, filed Jun. 14, 2017, the contents of which are incorporated by reference herein in their entireties.

### BACKGROUND

Mobile communications continue to evolve. A fifth generation may be referred to as 5G. A previous (legacy) generation of mobile communication may be, for example, fourth generation (4G) long term evolution (LTE). Mobile wireless communications implement a variety of radio access technologies (RATs), such as New Radio (NR). Use cases for NR may include, for example, extreme Mobile Broadband (eMBB), Ultra High Reliability and Low Latency Communications (URLLC) and massive Machine Type Communications (mMTC).

### SUMMARY

Systems, methods, and instrumentalities are disclosed for receiving, at a wireless transmit/receive unit (WTRU), configuration information associated with beam failure recovery, detecting a beam failure and sending a first beam failure recovery request message on a first beam to a network entity, determining that a beam failure recovery response message has not been received using the configuration information associated with beam failure recovery, and if the WTRU is associated with a static rotation state or a low rotation state, performing a per-beam based recovery, and if the WTRU is associated with a high rotation state, performing an omni-directional beam recovery.

The WTRU may determine a rotation state and send an indication of the determined rotation state. The configuration information associated with beam failure recovery may include a maximum number of beam failure recovery request messages. The configuration information associated with beam failure recovery may include a timer. The per-beam based recovery may comprise the WTRU sending a second beam failure recovery request message on a second beam (e.g., if the first beam failure recovery request message was sent at a maximum power). A beam failure recovery request message may be sent over multiple beams simultaneously. A beam failure recovery request message on an omni-directional beam (e.g., if a maximum number of non-omni-directional beam failure recovery request messages have been sent and the beam failure recovery response message has not been received). A radio link failure may be triggered (e.g., when a maximum number of beam failure recovery request messages have been sent and the beam failure recovery response message has not been received or when the beam failure recovery response message has not been received by the expiration of a timer).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 10 is a system diagram illustrating an example radio access network (RAN) and an example core network (CN) that may be used within the communications system illustrated in FIG. 1A according to an embodiment.

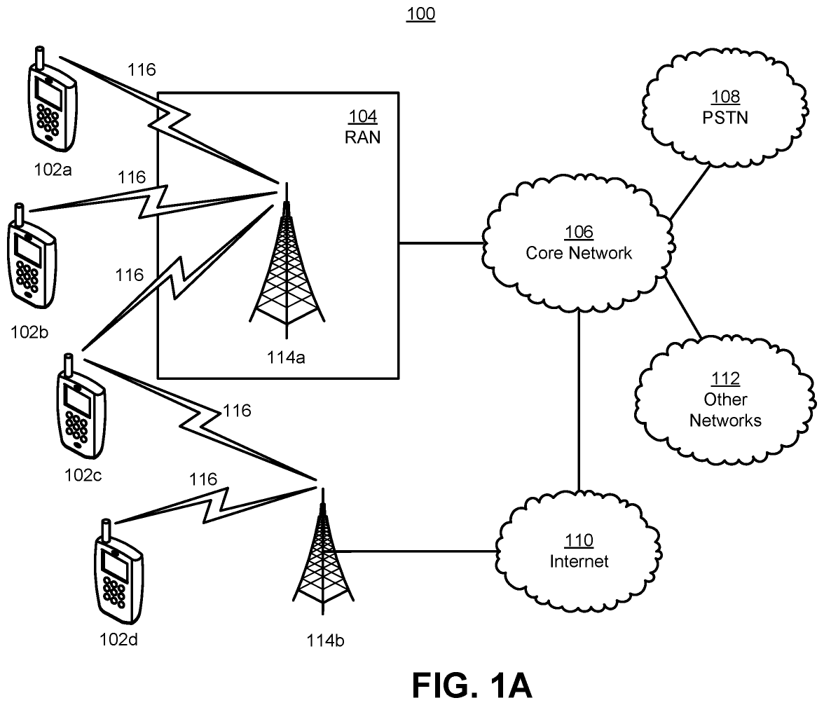

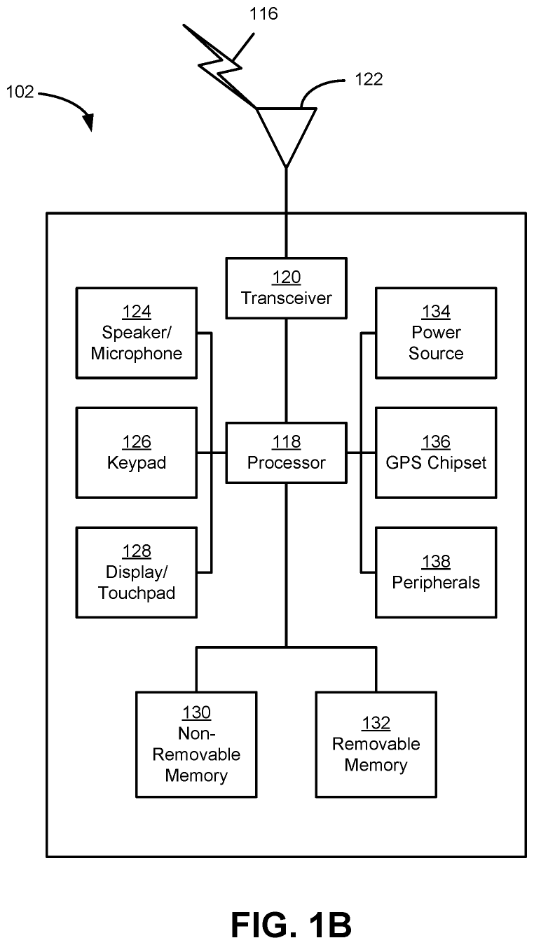

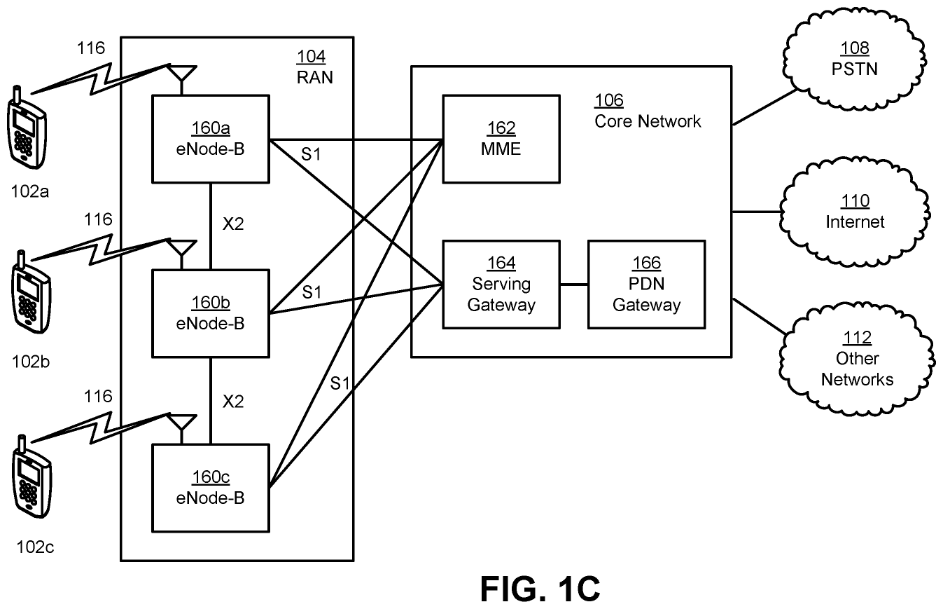

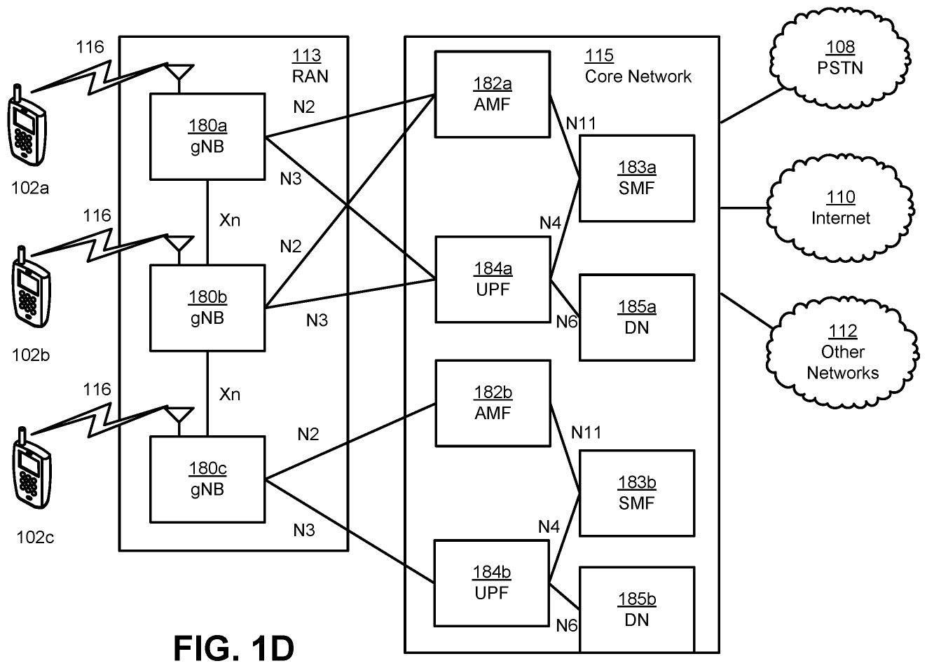

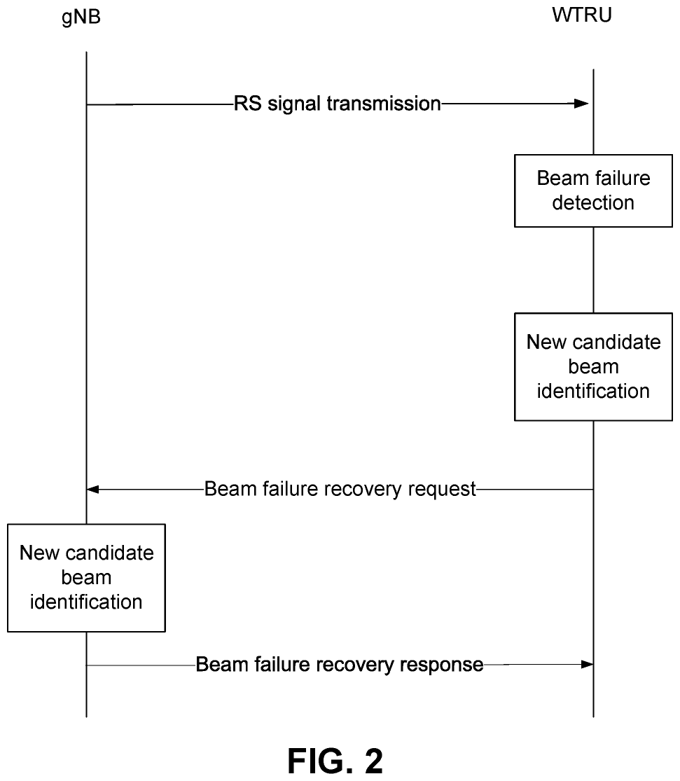

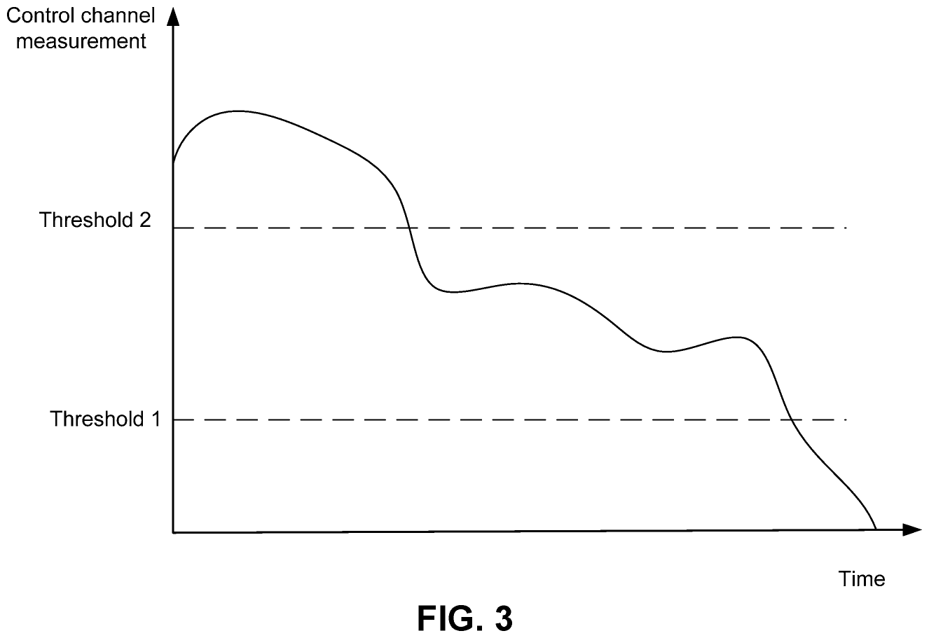

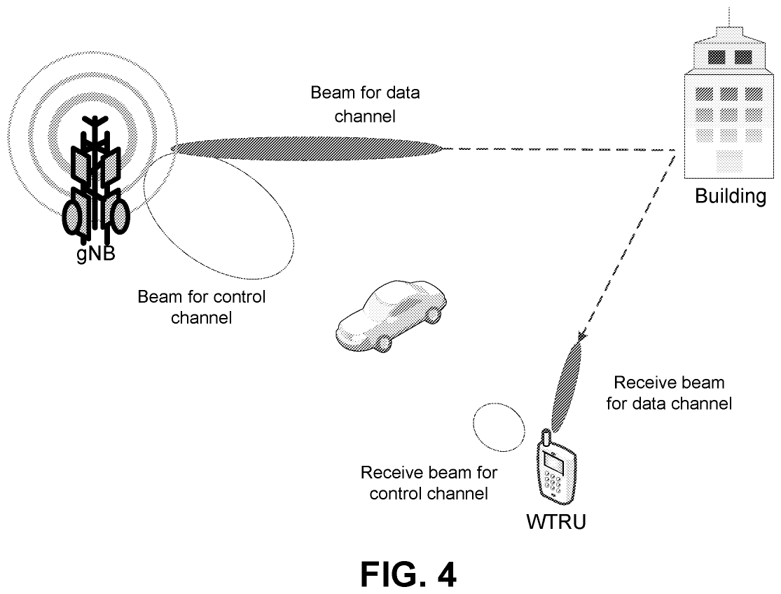

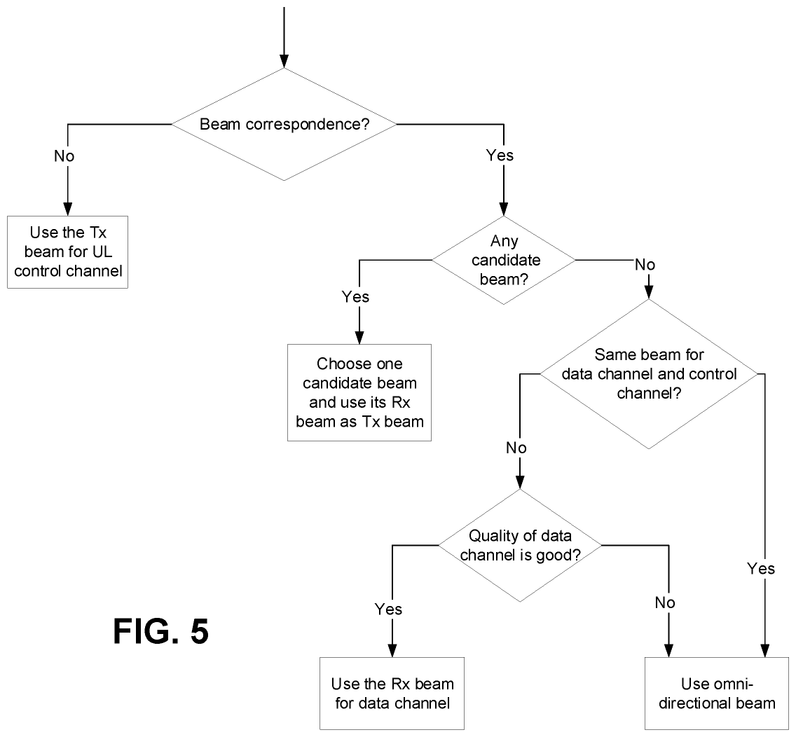

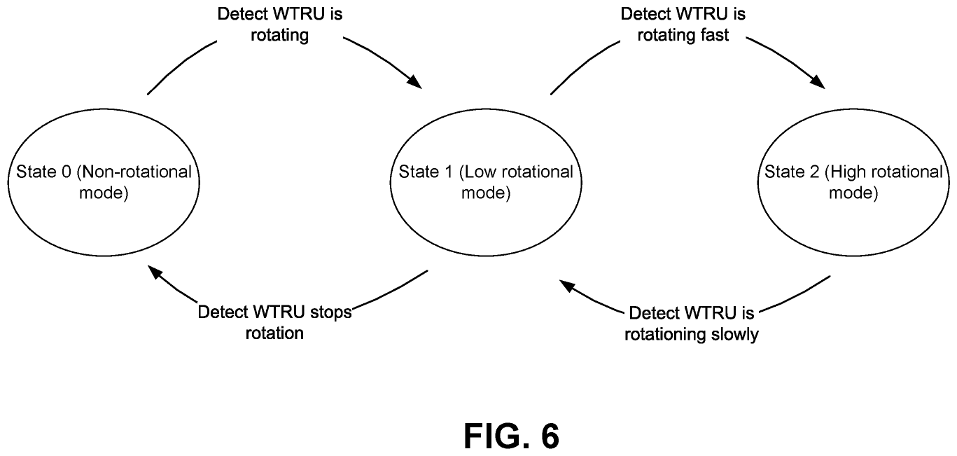

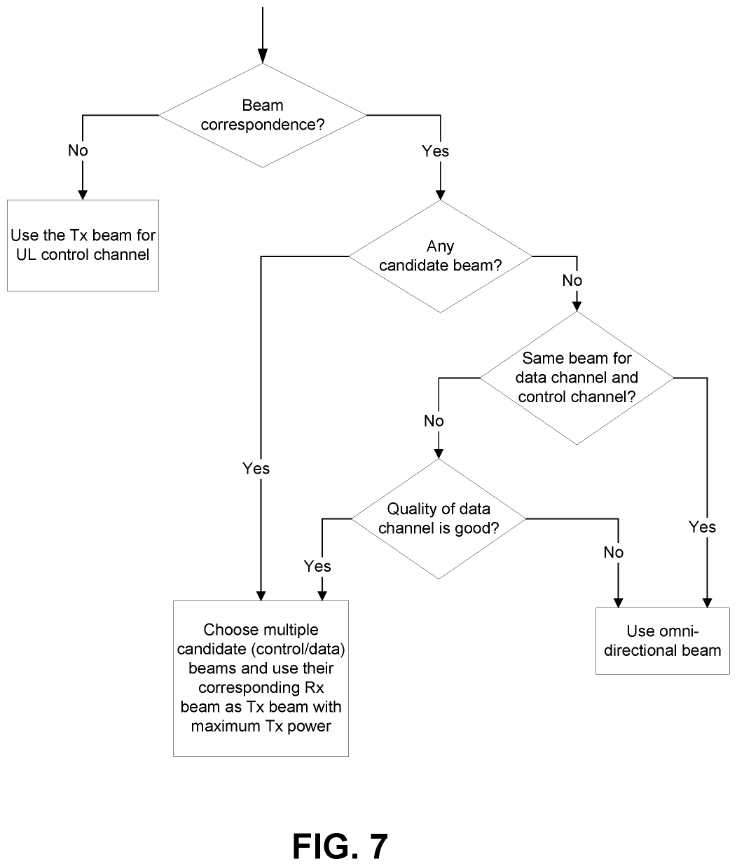

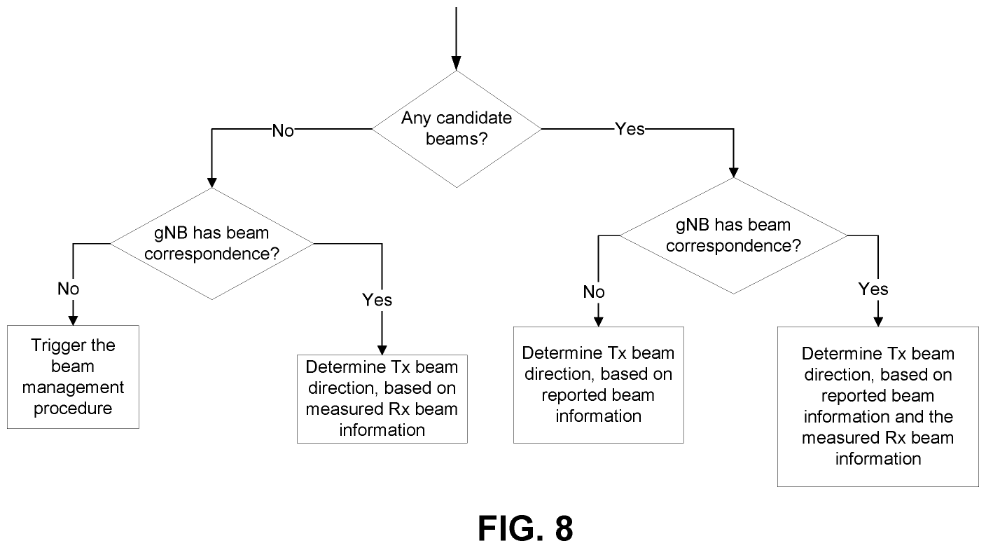

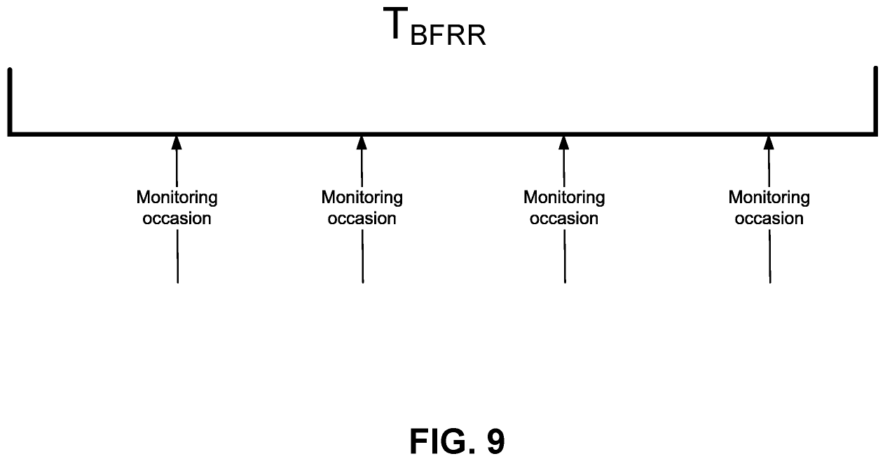

FIG. 1D is a system diagram illustrating a further example RAN and a further example CN that may be used within the communications system illustrated in FIG. 1A according to an embodiment.

FIG. 2 depicts an example of a beam recovery mechanism.

FIG. 3 is an example of multiple thresholds for beam failure detection.

FIG. 4 is an example scenario where beams for a data channel may be different from beams for a control channel.

FIG. 5 is an example of a WTRU determining a beam for a beam failure recovery request message.

FIG. 6 is an example of tracking WTRU rotation states.

FIG. 7 is an example of a WTRU determining a beam for a beam failure recovery request message in a first WTRU rotational state.

FIG. 8 is an example for a next generation Node B (gNB) after receiving a beam failure recovery request message.

FIG. 9 is an example of a monitoring occasion being uniformly distributed within a timer.

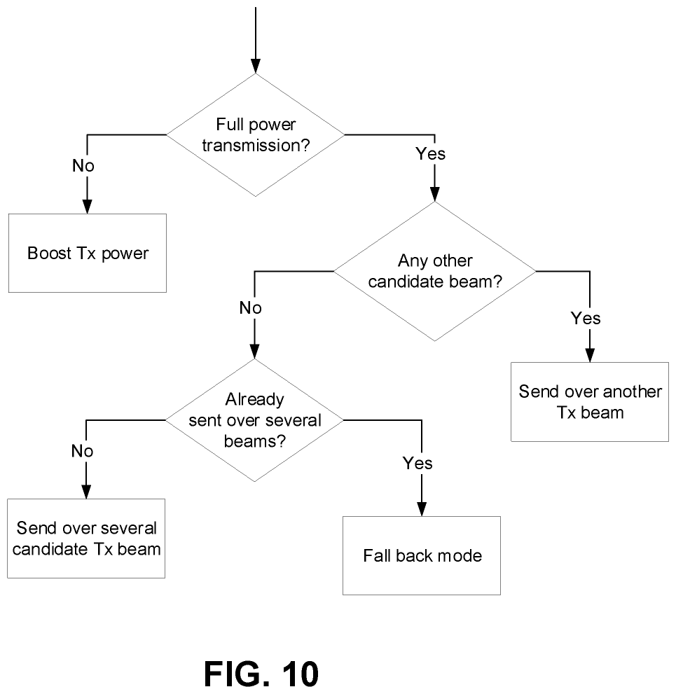

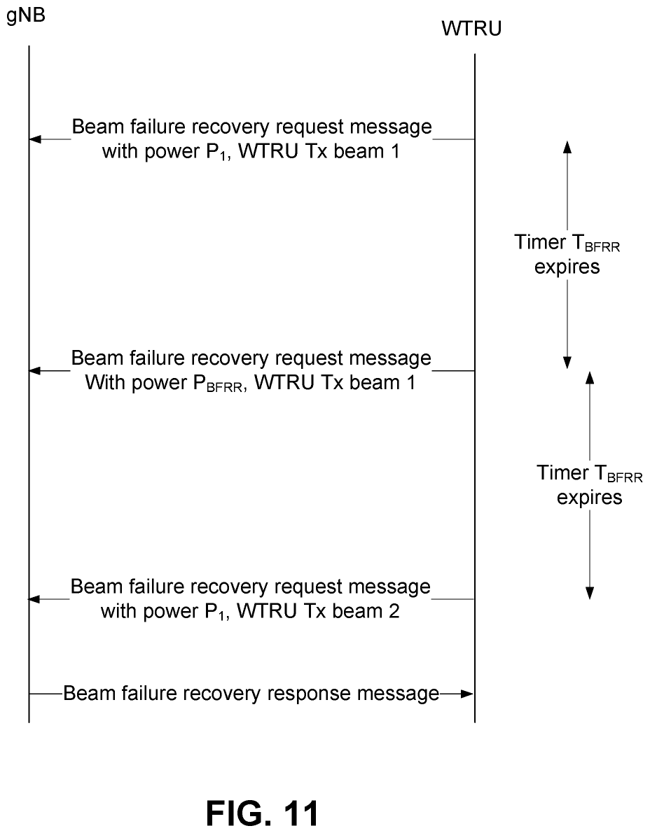

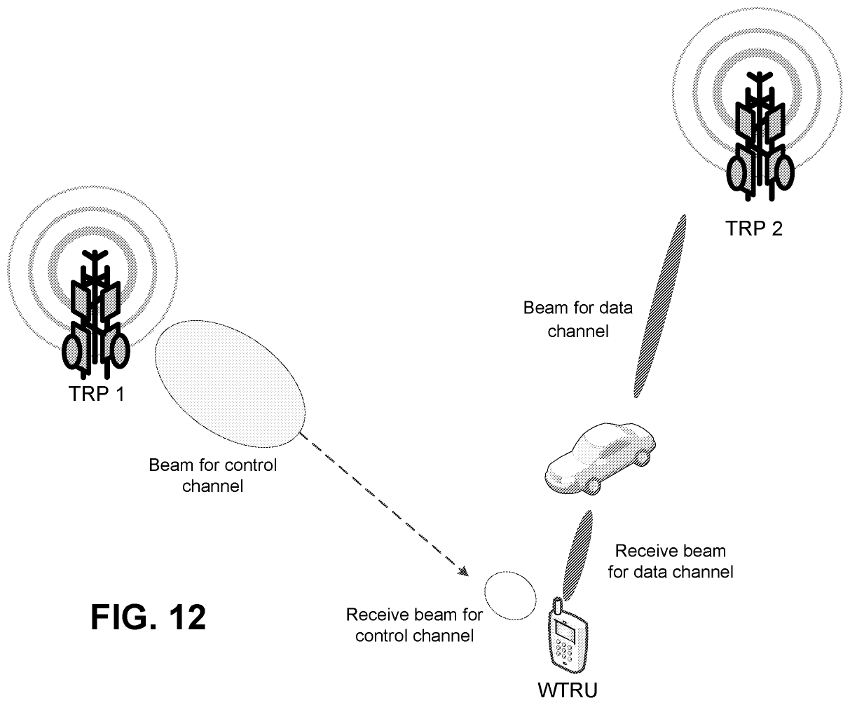

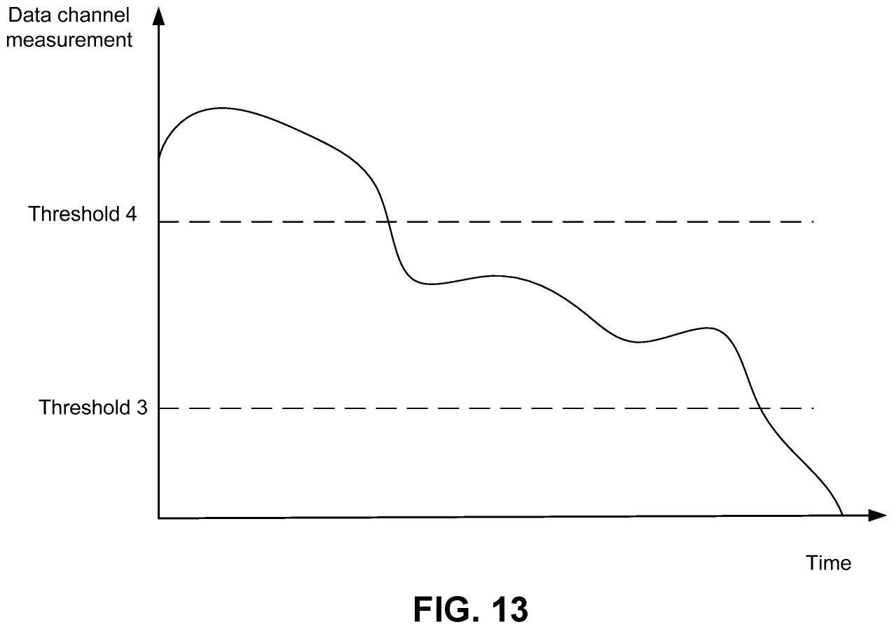

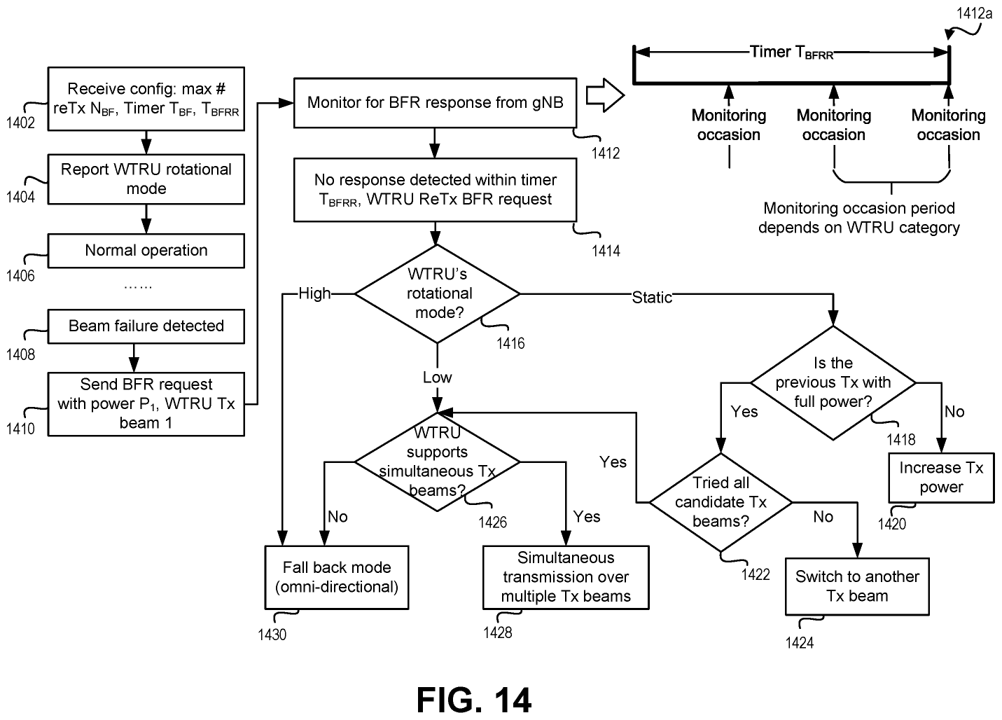

FIG. 10 is an example when a timer expires without receiving a response to a beam failure recovery request message.

FIG. 11 is an example for beam failure recovery request messages.

FIG. 12 is an example scenario with multiple TRPs where beams for a data channel may be different from beams for a control channel.

FIG. 13 is an example of multiple thresholds for beam failure detection for a data channel.

FIG. 14 is an example of a WTRU handling beam failure recovery request messages.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 10 is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 10, the eNode-Bs 160a, 160b, 160c may communicate with one another over an X2 interface.

The CN 106 shown in FIG. 10 may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU/UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Examples provided herein do not limit applicability of the subject matter to other wireless technologies, e.g., using the same or different principles as may be applicable.

Path loss may be significant for wireless communication at frequencies above 6 GHz. High path loss in a high frequency domain may be compensated for by, for example, beam management. In an example, some narrow beams may enhance signal power in certain directions. Narrow beams may be sensitive, for example, to dynamic blockage, WTRU rotational motion, and WTRU movement.

Beam management may be provided, e.g., for New Radio (NR). Propagation characteristics of higher band frequencies may influence system design. A communication channel may experience higher path losses and more abrupt changes as frequencies increase, for example, due to blockage, reduced transmission through objects, increased or amplified reflections, and WTRU rotation and movement.

FIG. 2 is an example of a beam recovery mechanism. In an example, a WTRU beam failure recovery may include, for example, beam failure detection, new candidate beam identification, beam failure recovery request transmission, and/or WTRU monitoring for gNB response for beam failure recovery request.

In an example of beam failure detection, a WTRU may monitor beam failure detection reference signal (RS), for example, to assess whether a beam failure trigger condition may be met. A beam failure detection RS may include a periodic Channel State Information Reference Signal (CSI-RS), e.g., for beam management. A serving cell may have a synchronization signal (SS) block, for example, when an SS-block may be used in beam management. A trigger condition may be provided for declaring beam failure.

In an example of new candidate beam identification, a WTRU may monitor a beam identification RS, e.g., to find a new candidate beam. A beam identification RS may include, for example, (i) a periodic CSI-RS for beam management (e.g., configured by network (NW)); and/or (ii) periodic CSI-RS and SS-blocks within a serving cell (e.g., when SS-block may be used in beam management).

In an example of a beam failure recovery request transmission, information carried by a beam failure recovery request may include, for example, (i) explicit/implicit information about identifying a WTRU and new gNB TX beam information; (ii) explicit/implicit information about identifying a WTRU and whether a new candidate beam exists; (iii) information that may indicate a WTRU beam failure; and/or (iv) other information (e.g., new beam quality).

A down-selection may be made between options for a beam failure recovery request transmission, such as PRACH, PUCCH, and PRACH-like (e.g., different parameter for preamble sequence from PRACH).

A beam failure recovery request resource/signal may be used for a scheduling request.

In an example of a WTRU monitoring a control channel search space (e.g., to receive a gNB response for a beam failure recovery request), a control channel search space may be the same or different from a current control channel search space that may be associated with serving BPLs.

A beam recovery mechanism may, for example, (i) detect a beam failure event; (ii) provide content and transmission of a beam failure recovery request message; (iii) be used by a WTRU, e.g., when a response to the request may not be received; (iv) provide one or more beam recovery schemes for multiple beam pair links (BPLs) and/or (v) handle a beam failure on a data channel and/or on a control channel.

Beam failure detection may be performed (e.g., as shown in FIG. 14 at 1408). A WTRU may be connected to a gNB, e.g., using a beam transmission. A WTRU may monitor a beam failure detection RS, for example, to assess whether a beam failure trigger condition may be met. A beam failure detection RS may include, for example, a periodic CSI-RS for a beam.

A beam failure event may occur, for example, when a quality of one or more beam pair links of an associated control channel may fall below one or more thresholds or otherwise satisfy one or more trigger conditions.

One or more trigger conditions may be used (e.g., by a WTRU) for declaring beam failure and association with beam measurements.

A measurement may be based on a periodic CSI-RS, aperiodic CSI-RS, and/or other signal(s) to be measured. In an example, a measurement metric may be a beam-specific Reference Signal Received Power (RSRP). Other measurement metrics may be implemented.

Beam failure detection may be based on one or more thresholds. In an example, a beam failure event may be declared, for example, when a serving beam's RSRP may be below a threshold. In an (e.g., another) example, a beam failure event may be declared, for example, when a serving beam's RSRP may be below a threshold for a certain time (e.g., for X periodic CSI-RS measurements).

FIG. 3 is an example of multiple thresholds for beam failure detection. In an example, multiple (e.g., two) threshold values may be applied in beam failure detection and associated beam measurements. In an example, Threshold 2>Threshold 1 (e.g., as shown in FIG. 3). One or more of the following may apply.

Other candidate beams may not be measured, for example, when a serving beam's RSRP may be above Threshold 2. For example, the WTRU may undergo normal operation (e.g., as shown in FIG. 14 at 1406). Ignoring measurement of other beams may, for example, save processing time and energy at a WTRU.

A beam failure event may be declared (e.g., immediately or after X periodic CSI-RS measurements), for example, when a serving beam's RSRP may be below Threshold 1. This type of beam failure detection may be referred to as a Type I beam failure.

Beam quality may be acceptable (e.g., although undesirable), for example, when a serving beam's RSRP may be between Threshold 1 and Threshold 2. Other candidate beams may be measured and tracked. The number of candidate beams to track may depend, for example, on a serving beam's RSRP values. A periodicity of measuring a candidate beams may (e.g., also) depend on a serving beam's RSRP values.

Measurement of candidate beams may be triggered, for example, when a serving beam's RSRP may fall below Threshold 2 for a certain time (e.g., for X₁ periodic CSI-RS measurements).

A beam may be switched, for example, when a candidate beam's RSRP may be above Threshold 2 for a certain time (e.g., X₂ periodic CSI-RS measurements) while a serving beam's RSRP may remain between Threshold 1 and Threshold 2. In an example, beam failure detection may be declared, for example, when a serving beam's RSRP may not fall below Threshold 1. This type of beam failure detection may be referred to as a Type II beam failure.

A beam failure may not be declared when a serving beam's RSRP value remains above Threshold 1. A beam failure event may be declared, for example, when a serving beam's RSRP value may be below Threshold 1 for a certain time (e.g., X₃ periodic CSI-RS measurements, where X₃ may be less than X in the second example).

Examples/implementations may be extended to more than two thresholds.

Thresholds (e.g., Threshold 1 and Threshold 2) may be configured, for example, via RRC signaling. Thresholds may be indicated, for example, in an RRC connection establishment, RRC connect reconfiguration, and/or RRC connection re-establishment messages. In an example, the following may be added to RRCConnectionReconfiguration IE:

RRCConnectionReconfiguration ::= SEQWTRUNCE {

| ...... | |
|---|---|
| BmrecoveryThreshold1 | ENUMERATED {dB_low,...,dB_high} |

| | |
|---|---|
| BmrecoveryThreshold2 | ENUMERATED {dB_low,...,dB_high} |

......

}

A usage of Type I beam failure and/or Type II beam failure may depend on a WTRU capability (e.g., or category). For example, a low capability WTRU may not be able to monitor candidate beams, and may (e.g., may only) monitor the serving beam. In this example, only Type I beam failure may be detected (e.g., the WTRU may not identify and report candidate beams). For example, a high capability WTRU may be able to monitor many candidate beams, and may detect both Type I beam failure and Type II beam failure.

A usage of Type I beam failure and/or Type II beam failure may depend on gNB configuration. A gNB may configure some WTRUs for (e.g., only for) Type I beam failure. This may be, for example, because of a low mobility of these WTRUs. A gNB may configure other WTRUs for both Type I beam failure and Type II beam failure. This may be, for example, because of a high mobility of these WTRUs.

A beam failure recovery request transmission may be provided. In an example, a beam failure recovery request message may be categorized by its corresponding mode, for example, depending on an availability of a candidate beam and a type of beam failure(s). TABLE 1 shows an example of information, one or more parts of which may be indicated in a beam failure recovery request message.

TABLE 1

| | | Candidate | | | Additional |
|---|---|---|---|---|---|
| Beam | | Tx | Candidate Tx | Old beam | information |
| failure | | beam(s) | beam(s) RSRP | RSRP value | (candidate beam |
| type | Descriptions | ID | value (dBm) | (dBm) | reliability/quality) |
| 0 | Type I beam failure with | NA | NA | −100 | NA |
| | no candidate beam | | | | |
| 1 | Type I beam failure with | 1 | −60 | −100 | 70% |
| | candidate beam | | | | |
| 2 | Type II beam failure | (2, 3) | (−86, −75) | −90 | (60%, 80%) |

A type 0 beam failure may indicate (e.g., imply) a Type I beam failure event and no candidate beam, which may be due to a sudden beam pair link quality degradation with insufficient time to measure candidate beams or may be due to a lack of candidate beams satisfying a threshold. In an example, a previously serving (e.g., old) beam's RSRP value may be added, e.g., for reference by a gNB.

A type 1 beam failure may indicate a Type I beam failure event with one or more candidate beams. A candidate transmission beam ID and an associated beam RSRP value may be included (e.g., in a request). A previously serving (e.g., old) beam's RSRP value may (e.g., also) be included (e.g., in a request). Other/additional information (e.g., a new beam's reliability) may (e.g., also) be included. Information obtained and/or provided in a request may, for example, depend on a duration that a measured RSRP value of a candidate beam may be above a threshold. Reliability of a candidate beam may increase with time above a threshold. Information may (e.g., also) depend on a difference between an RSRP value of a candidate beam and an RSRP value of an old beam. A difference may indicate (e.g., imply) a level of improvement or gain that may be achieved by switching to a new beam.

A type 2 beam failure may indicate a Type II beam failure event. There may (e.g., must) be one or more (e.g., good) candidate beams (e.g., by default). A request may, for example, provide information about a candidate transmission beam ID, RSRP values of an old beam and one or more candidate beams, and/or a reliability of one or more candidate beams.

An RSRP value for an old beam may indicate a quality of the old beam. A value may depend on an RSRP value for a control channel. A value may be an average of RSRP values in a plurality of CSI-RS measurements. A value may (e.g., at least partially) include an RSRP value for a data channel measurement. In an example, a value based on multiple measurement values may apply weighting (e.g., apply a higher weight to a control channel measurement and apply a lower weight to a data channel measurement).

RSRP may, for example, be used as a metric for beam measurement (e.g., as shown by example in TABLE 1). Other examples or implementations may use RSRP and/or other metrics, such as RSRQ, a CSI report and/or other metrics.

A beam failure recovery request message may be transmitted (e.g., by a WTRU). A beam failure event may be triggered, for example, when a measured control channel may fall below one or more thresholds. A WTRU may send a beam failure recovery request message (e.g., to a gNB), for example, after the WTRU detects a beam failure event. A WTRU may use one or more transmit beams to transmit a request message.

A beam failure event may indicate that a downlink control channel may not be in good (e.g., acceptable) condition. A beam failure event may not indicate (e.g., imply) that an uplink control channel may not be in good condition. Lack of beam correspondence may indicate that an uplink control channel may not share the same beam as a downlink control channel. Transmission of a beam failure recovery request message may be made, for example, through PUCCH, e.g., via a transmit beam that may be used for an uplink control channel.

In the case when beam correspondence holds, such beam correspondence may indicate that an uplink control channel may be degraded when a downlink control channel may be degraded, which may prevent sending a beam failure recovery request message using the Tx beam for uplink control channel.

In examples, a candidate beam may (e.g., already) be detected by a WTRU (e.g., at a time when a beam failure recovery request message may be needed). For example, beam failure recovery modes 1 and 2 in TABLE 1 may imply the existence of one or more candidate beams. A WTRU may select a candidate beam and may use its Rx beam as a Tx beam to send a beam failure recovery request message. Selection of a candidate beam may depend on, for example, (i) an RSRP value of a beam pair link (e.g., select a beam pair link with the highest RSRP value); (ii) a reliability of a beam pair link (e.g., select a beam pair link with the highest reliability value); and/or (iii) combined RSRP and reliability of a beam pair link.

In an example where a candidate beam may be unavailable (e.g., beam failure recovery mode 0 in TABLE 1), a WTRU may determine whether a DL control channel and a DL data channel may be using the same beam direction. A DL control channel and a DL data channel may use different beams or different beam directions.

FIG. 4 is an example scenario where beams for a data channel may be different from beams for a control channel. This scenario may (e.g., also) exist, for example, when a control channel beam may be from a first TRP and a data channel beam may be from a non-collocated TRP.

A WTRU may check a quality of a DL data channel, for example, when a DL data channel and DL control channel may not share the same beam direction. A WTRU may (e.g., when a DL data channel may have good quality) use the direction of an Rx beam of a data channel to transmit a beam failure recovery request message.

A WTRU may use a wide beam to transmit a beam failure recovery request message, for example, when a data channel and a control channel may share the same beam direction or when a quality of a data channel may (e.g., also) not be good.

FIG. 5 is an example of a WTRU determining a beam for a beam failure recovery request message. A WTRU may determine a beam direction for beam failure recovery request message.

Beam failure may be caused, for example, by dynamic blockage, WTRU movement, and/or WTRU rotation. An angle of arrival and an angle of departure may (e.g., dramatically) change for WTRU rotation. Serving beams and candidate beams may be affected, e.g., simultaneously, by WTRU rotation. An omni-directional beam may be used to send a beam failure recovery request message, for example, in such cases where rotation dramatically changes conditions, e.g., high rotation.

FIG. 6 is an example of tracking WTRU rotation states. In an example, an algorithm or state machine may be used, for example, when a WTRU may have a capability of detecting its rotational movement. State 0 may indicate a WTRU may be in a static state (e.g., as shown in FIG. 14 at 1416), State 1 may indicate a WTRU may be in a low rotational mode, and State 2 may indicate a WTRU may be in a high rotational mode (e.g., as shown in FIG. 14 at 1416).

A WTRU in State 0 may, for example, determine a beam for a beam failure recovery request message (e.g., by an example in FIG. 5).

A WTRU in State 2 may, for example, use an omni-directional beam for a beam failure recovery request message (e.g., as shown in FIG. 14 at 1430) and may (e.g., also) reduce a candidate beam reliability level (e.g., by an example shown in TABLE 1).

A WTRU in State 1 may, for example, select one or more candidate beams and may send a beam failure recovery request message (e.g., simultaneously) over selected candidate beam(s) (e.g., as shown in FIG. 14 at 1428).

FIG. 7 is an example of a WTRU determining a beam for a beam failure recovery request message in a first WTRU rotational state (e.g., low rotational mode). In an example, a WTRU may attempt to use multiple (e.g., all) possible candidate beams, which may result in wider beams, to send a beam failure recovery message with higher transmission power. Candidate beams may include control channel beams and data channel beams. A beam width of a (e.g., each) candidate beam may be increased, for example, to enhance robust transmission.

A WTRU rotational state may (e.g., also) be included in a beam failure recovery request message (e.g., as shown in FIG. 14 at 1404). This may, for example, help a gNB to adjust a subsequent reaction.

Examples refer to three states to indicate a WTRU's rotational mode. These examples may be extended to more or less than 3 states, which may for example depend on a WTRU's rotational speeds and/or other parameters.

A beam failure recovery request message and/or information therein may be implicit. Example contents in a beam failure recovery request message and its transmission beam may include those described herein. TABLE 1 indicates information in a request message may include, for example, a candidate transmission beam ID and candidate transmission beam RSRP values. A beam to send a beam failure recovery request message may be selected, for example, depending on a candidate transmission beam.

Signaling overhead of the beam failure recovery request message may be reduced, for example, by not explicitly including candidate transmission beam information in the contents of a request message. A gNB may know (e.g., by receiving a beam failure recovery request message), for example, which direction of Rx beam may be good for a message. A gNB may (e.g., with beam correspondence), for example, send (e.g., by default) a beam failure recovery response message over a beam direction surmised to be good.

RSRP values (e.g., in TABLE 1) may be implicitly expressed, for example, based on relative values. In an example, a difference between RSRP values of candidate Tx beams and an RSRP value of a current Tx beam may be captured in a request message.

One or more features associated with a beam failure recovery response may be used, e.g., as disclosed herein. A gNB may perform certain actions after receiving a beam failure recovery request. Upon receiving a beam failure recovery request message, a gNB may check the contents of this message. If candidate beam(s) are identified in the message, the gNB may analyze the RSRP value(s) and the reliabilities of the candidate beams (e.g., as well as the RSRP value of the current beam). If the beam correspondence at the gNB holds, the gNB may (e.g., may also) get the side information from its own measurements of the Rx beams. With the information ready, the gNB may decide to switch the Tx beam direction of PDCCH. Alternatively, the gNB may decide not to switch the Tx beam direction of PDCCH.

If no candidate beam(s) are identified in the message, and the beam correspondence at gNB holds, the gNB may check its Rx beams and may decide whether or not to switch the Tx beam direction of PDCCH.

If no candidate beam(s) are identified in the message, and the beam correspondence at gNB does not hold, the gNB may trigger the beam management procedure, e.g., P-1/P-2/P-3 procedures.

FIG. 8 is an example of actions a gNB may take after receiving a beam failure recovery request message.

A WTRU monitoring beam failure recovery response message may be provided. A WTRU may (e.g., after sending a beam failure recovery request message) monitor to receive a gNB response to the beam failure recovery request. For example, a WTRU may monitor a control channel, e.g., a control channel search space, to receive a gNB response to the beam failure recovery request message (e.g., as shown in FIG. 14 at 1412). A WTRU may, for example, set up a timer T_{BFRR} for a response message (e.g., as shown in FIG. 14 at 1402). A WTRU may determine that a request message failed, for example, when the WTRU may not receive a beam failure recovery response message before expiration of the timer. The timer T_{BFRR} may be configured or may be pre-determined.

If a single candidate beam may be identified in the beam failure recovery request message, the WTRU may monitor the specific PDCCH for the beam failure recovery response message. The WTRU may assume that the corresponding PDCCH DM-RS is spatial QCL-ed with a RS of the WTRU-identified candidate beam. The WTRU may monitor the previous PDCCH as well (e.g., in case the gNB decides to keep the original beams).

If multiple candidate beams are identified in the beam failure recovery request message, the WTRU may monitor the specific PDCCH for the beam failure recovery response message. The WTRU may assume that the corresponding PDCCH DM-RS is spatial QCL-ed with a RS of the WTRU-identified candidate beam with the strongest signal level (e.g., RSRP value). The WTRU may monitor several PDCCH, for example, by assuming the corresponding PDCCH DM-RS is spatial QCL-ed with a RS of some of the WTRU-identified candidate beams. The set of monitoring PDCCH may be selected based on the signal levels of WTRU-identified candidate beams, e.g., the RSRP values larger than a threshold.

If no candidate beam may be identified in the beam failure recovery request message, the WTRU may monitor the PDCCH from the possible beam directions, from a pre-configured set of beam directions, or from the same direction as the previous PDCCH.

Within a time window T_{BFRR}, a WTRU may have a single or multiple monitoring occasions. For example, a WTRU may expect the beam failure recovery response message at exact W TTIs after the beam recovery request message. For example, a WTRU may expect the beam failure recovery response message at any time later than W TTIs after the beam recovery request message. For example, a WTRU may expect the beam failure recovery response message at every W TTIs after the beam recovery request message.

A number of monitoring occasions within the time window T_{BFRR} may be configured (e.g., as Nₘₒₙᵢₜₒᵣ). Monitoring occasions may be equally distributed among the time window T_{BFRR} (e.g., as shown in FIG. 14 at 1412a). FIG. 9 is an example of a monitoring occasion being uniformly distributed within a timer, where Nₘₒₙᵢₜₒᵣ is equal to 4.

A WTRU may not receive a beam failure recovery response message. A WTRU may not receive a beam failure recovery response message, for example, when the WTRU's beam failure recovery request message may not reach a gNB or when the WTRU may not decode a gNB's beam failure recovery response message.

A WTRU may re-transmit a beam failure recovery request message, for example, with a change in Tx beam direction and/or a boost in transmission power (e.g., see FIG. 14).

FIG. 10 is an example for when a timer expires without receiving a response to a beam failure recovery request message. One or more of the following may apply. A WTRU may (e.g., first) determine whether an increase in transmission power may be allowed for message retransmission. A maximum transmission power for a beam failure recovery request message may be predefined or configured, for example, as P_{BFRR} (e.g., as shown in FIG. 14 at 1418). Retransmission with increased transmission power may occur, for example, when permissible (e.g., as shown in FIG. 14 at 1420). A WTRU may (e.g., otherwise) determine whether other candidate beams may be used in a retransmission (e.g., as shown in FIG. 14 at 1422). Retransmission using one or more other candidate beams may occur, for example, when other candidate beam(s) exist (e.g., as shown in FIG. 14 at 1424). Retransmission using a combination of multiple (e.g., all) candidate beams may occur (e.g., as shown in FIG. 14 at 1428), for example, when all individual candidate beams may have been used in a previous transmission of the request message (e.g., as shown in FIG. 14 at 1426). A WTRU may (e.g., failing other options), retransmit the request message in a fall back mode, where (re)transmission may be omni-directional (e.g., as shown in FIG. 14 at 1430).

FIG. 11 is an example for beam failure recovery request messages. In an example, a (e.g., first) beam failure recovery request message may be transmitted with transmission power P₁ and WTRU Tx beam 1 (e.g., as shown in FIG. 14 at 1410). In an example, the message may not be received at a gNB, for example, due to a power limitation and/or due to an improper beam direction.

Timer T_{BFRR} may expire without the WTRU receiving a beam failure recovery response. The WTRU may, for example, apply decision making (e.g., as shown in FIG. 10) to decide on one or more Tx beams and Tx power for a next beam failure recovery request message (e.g., as shown in FIG. 14 at 1414). In an example, a WTRU may send a second beam failure recovery request message with an increase in a power level using the same Tx beam (e.g., as shown in FIG. 14 at 1420).

Timer T_{BFRR} may expire without the WTRU receiving a beam failure recovery response. The WTRU may, for example, apply decision-making (e.g., as shown in FIG. 10) to decide on one or more Tx beams and Tx power for a next beam failure recovery request message. In an example, a WTRU may send a third beam failure recovery request message using a different Tx beam and may use a reduced power level (e.g., as shown in FIG. 14 at 1424). The WTRU may, for example, receive a beam failure recovery response message.

A maximum number N_{BF} of beam failure recovery request messages may be configured (e.g., as shown in FIG. 14 at 1402). A radio link failure may be triggered, for example, when N_{BF} may be reached. In an (e.g., alternative) example, a longer timer T_{BF} may be configured (e.g., as shown in FIG. 14 at 1402). A longer timer may, for example, start with a first beam failure recovery request message (or beam failure detection event declared by WTRU) and may stop with a corresponding beam failure recovery response message. If a longer timer expires, a message may be sent to an upper layer, for example, to trigger a radio link failure event.

The maximum number of beam failure recovery request message N_{BF} and the timer T_{BF} may be used jointly. For example, if the number N_{BF} is reached or the timer T_{BF} expires, the radio link failure event may be triggered. For example, if the number N_{BF} is reached and the timer T_{BF} expires, the radio link failure event may be triggered.

The values of Nₘₒₙᵢₜₒᵣ, T_{BFRR}, P_{BFRR}, T_{BF}, and N_{BF} may be configured, for example, in an RRC message. Values may be indicated, for example, in RRC connection establishment, RRC connect reconfiguration, and/or RRC connection re-establishment messages. In an example, the following may be added to RRCConnectionReconfiguration IE:

RRCConnectionReconfiguration ::= SEQWTRUNCE {

| ...... | |
|---|---|
| BmrecoveryTimer | ENUMERATED {ms100,, ms300, ms500, ms1000} |

| | |
|---|---|
| BmrecoveryPower | ENUMERATED {dB_low,...,dB_high} |
| BMrecoveryTotalTimer | ENUMERATED {ms1000, ms2000, ms3000, ms5000} |
| BMrecoveryTrialNum | INTEGER {3..5} |
| BMrecoveryMonitorNum | INTEGER {3..5} |
| ...... | |

}

Multiple simultaneous beam pair links (BPLs) may be simultaneously used, e.g., between a gNB and a WTRU. Beam failure detection for multiple beam pair links may be based on multiple thresholds. In an example, there may be Y beam pair links between gNB and WTRU.

A WTRU may monitor multiple (e.g., all) beams and may perform a periodic measurement of RSRPs of beams on a control channel. In an example, a WTRU may calculate average RSRP values of beams (e.g., after each measurement), which may result in a single RSRP value for each measurement. A WTRU may, for example, apply multiple (e.g., two) thresholds, e.g., to declare a beam failure event. In an (e.g., alternative) example, a WTRU may track an (e.g., each) individual beam. In an example, a beam may be failed, for example, when an RSRP of a beam may be (e.g., is) below Threshold 1 (e.g., for a certain duration). A beam failure event may be declared, for example, when a certain percentage U₁% of Y beams may be counted as failures, which may correspond to a Type I beam failure in a previous example.

In an example, a beam failure may be declared, for example, when there may be U₂% of Y serving beams with RSRP values between Threshold 1 and Threshold 2 (e.g., for a certain duration) while other Z (Z≥Y·U₂%) non-serving beams with RSRP values may be above Threshold 2, which may correspond to a Type II beam failure in a previous example.

The values of U₁ and U₂ may be configured, for example, via RRC messages. A Type I beam failure and a Type II beam failure may be jointly used. In an example, among Y beams, Y₁ beams may have RSRP values that may be less than Threshold 1 while Y₂ beams may have RSRP values between Threshold 1 and Threshold 2. Simultaneously, Z≥Y₂ non-serving beams may have RSRP values above Threshold 2. Continuing with the example, where

$$\frac{{Y}_{1}}{Y} < {U}_{1} \% and \frac{{Y}_{2}}{Y} < {U}_{2} \% ,$$

neither a Type I beam failure event nor a Type II beam failure event may be declared. The combined situation may imply, however, that an overall beam situation may not be good (e.g., is unsatisfactory). A beam failure event may be declared. This type of beam failure may be referred to as a Type III beam failure.

A WTRU may (e.g., once the beam failure event may be declared) send a beam failure recovery request message to gNB.

TABLE 2 shows an example of information, one or more parts of which may be indicated in a beam failure recovery request message for multiple beam pair links. TABLE 2 shows IDs for old beams, for example, because not all beams may be replaced or removed in a beam failure event with multiple beam pair links. Some beam pair links may be in good condition while other beam pair links may be in bad condition. A beam failure recovery request message may, for example, indicate (e.g., only) a portion of beams (e.g., serving beams to be replaced). A candidate beams list may, for example, be implicitly indicated by beams that may be used to send a beam failure recovery request message.

TABLE 2

| | | | Old beam | Candidate | Candidate | Additional |
|---|---|---|---|---|---|---|
| Beam | | Old | RSRP | Tx | Tx beam(s) | information |
| failure | | beam(s) | value | beam(s) | RSRP value | (new beam |
| type | Descriptions | ID | (dBm) | ID | (dBm) | reliability/quality) |
| 0 | Type I beam | (1, 2) | −100 | NA | NA | NA |
| | failure with no | | | | | |
| | candidate beam | | | | | |
| 1 | Type I beam | 2 | −100 | (3, 4) | (−60, −74) | (70%, 75%) |
| | failure with | | | | | |
| | candidate beam | | | | | |
| 2 | Type II beam | (1, 2) | −90 | (2, 3) | (−86, −75) | (60%, 80%) |
| | failure | | | | | |
| 3 | Combined Type I | (1, 2, 3) | −90 | (4, 5, 6) | (−65, −70, −75) | (70%, 65%, 75%) |
| | and Type II | | | | | |
| | beam failure | | | | | |

Beam failure may occur for a data channel. A beam for a data channel may have a different direction than a beam for a control channel. FIG. 4 shows an example. FIG. 12 shows another example.

FIG. 12 is an example scenario with multiple TRPs where beams for a data channel may be different from beams for a control channel. In an example, a WTRU may receive control information from TRP 1 and data information from TRP 2.

There may be several failure conditions for a control channel and data channel: (i) a control channel may be good while a data channel may be bad; (ii) a control channel may be bad while a data channel may be good; and (iii) a control channel may be bad and a data channel may be bad. Beam failure detection may, for example, depend on a control channel (e.g., ii and iii). It may also be desirable to consider the failure on data channel (e.g., i and iii).

In an example, beam failure detection based on a data channel may follow a similar mechanism as for a control channel (e.g., FIG. 13), and in examples, with stricter criteria. Measurement of a data channel may, for example, be on DMRS, CSI-RS, or actual data decoding results (e.g., ACK/NACK condition). An example beam failure criteria may be, for example, when an RSRP of a CSI-RS may fall below a threshold T, e.g., for more than Y measurements, with Z continuous data decoding failures.

FIG. 13 is an example of multiple thresholds for beam failure detection for a data channel.

A beam failure event on a data channel may be declared independent of a beam failure event on a control channel. A beam failure event may be declared, for example, based on a joint detection of a control channel and a data channel.

A beam failure even may be declared, for example, when a control channel beam RSRP value may fall between Threshold 1 and Threshold 2 (e.g., in FIG. 3) while a data channel beam RSRP value may fall between Threshold 3 and Threshold 4 (e.g., in FIG. 13). Thresholds 3 and 4 (e.g., like Thresholds 1 and 2) may be configured, e.g., via RRC signaling.

A control channel beam RSRP value may fall below Threshold 1. A WTRU (e.g., that may not consider a data channel) may declare a beam failure event, for example, after Y measurements with an RSRP value below Threshold 1. A WTRU (e.g., that may consider a data channel) may declare a beam failure event, for example, when an RSRP of a data channel also falls below Threshold 3 and after Y₁<Y measurements on control channel with RSRP value below Threshold 1.

A control channel beam RSRP value may fall between Threshold 1 and Threshold 3. A WTRU (e.g., that may not consider a data channel) may not declare a beam failure, for example, when there may not be a candidate control channel beam with RSRP values larger than Threshold 1. A WTRU may declare beam failure, for example, when a data channel beam (e.g., immediately) falls below Threshold 3.

Other combined consideration of data channel beam and control channel beam measurements may be performed to declare (or not declare) a beam failure event. Other considerations may, for example, be based on a control channel and data channel sharing one or more common beam directions.

Contents of a beam failure recovery request message may, for example, include an item for beam type. In an example, beam type 0 may indicate (e.g., imply) a beam failure (e.g., only) on a control channel, beam type 1 may indicate a beam failure (e.g., only) on a data channel, and beam type 2 may indicate beam failure on both a control channel and a data channel.

In an example with (e.g., only) a data channel failure, an old beam and candidate beam may refer to data channel beams. In an example with both data channel and control channel failure, it may be unnecessary to identify whether an old beam and a candidate beam may be for control channel or for data channel.

In an example with (e.g., only) control channel beam failure, e.g., beam type=0, contents of a beam failure recovery request message may (e.g., also) contain data channel beam information, e.g., an RSRP value of a data channel. This information may assist a gNB with a determination about new beams that may be used for a failed control channel. A beam that may be used to send a beam failure recovery request message may follow a beam direction of a data channel. In an example, a control channel may have a wider beam than a data channel. A beam direction of a control channel may be centered at a beam direction of a data channel.

TABLE 3 shows an example of information, one or more parts of which may be indicated in a beam failure recovery request message for data and control channels.

TABLE 3

| | | | Candidate | Candidate | Old beam | Additional |
|---|---|---|---|---|---|---|
| | Beam | | Tx | Tx beam(s) | RSRP | information |
| Beam | failure | | beam(s) | RSRP value | value | (new beam |
| type | type | Descriptions | ID | (dBm) | (dBm) | reliability/quality) |
| 0 | 0 | Control channel | NA | NA | −100 | NA |
| | | Type I beam | | | | |
| | | failure with no | | | | |
| | | candidate beam | | | | |
| 1 | 1 | Data channel | 1 | −60 | −100 | 70% |
| | | Type I beam | | | | |
| | | failure with | | | | |
| | | candidate beam | | | | |
| 2 | 2 | Both data | (2, 3) | (−86, −75) | −90 | (60%, 80%) |
| | | channel and | for data | for data | for data | for data |
| | | control channel | channel 2 | channel −70 | channel −85 | channel 75% |
| | | Type II beam | for control | for control | for control | for control |
| | | failure | channel | channel | channel | channel |

A gNB may respond differently, for example, depending on a beam type in a beam failure recovery request message.

A beam association between a data channel and a control channel may be managed during a beam failure recovery. A TRP may (e.g., at the end of a DL beam management procedure, such as a P1 procedure) send a beam indication to a WTRU (e.g., to inform a WTRU about Tx beam related information). This indication may facilitate an optimal reception by a WTRU.

An indication of spatial QCL assumption between DL RS antenna ports and DMRS antenna ports of a DL data channel may be supported, e.g., for reception of a unicast DL data channel. Information, e.g., via DCI (downlink grants), may indicate, for example, RS antenna ports, which may be QCL-ed with DMRS antenna ports.

An association between a data channel and a control channel may be established, for example, in a beam management. An association between a data channel and a control channel may be ruined, for example, in a case of beam failure. In an example, a bad control channel condition or a bad data channel condition may lead to a beam failure event.

In an example with a bad data channel and a good control channel, an association between a data channel and a control channel may (e.g., should) not be maintained. In an example with a bad control channel and a good data channel, an association between a data channel and a control channel may not be maintained. A dis-association between data channel and control channel may, for example, be contained in a beam failure recovery.

A WTRU may determine whether a data channel or a control channel may be bad, for example, based on beam measurements on a data channel and a control channel. A WTRU may decide whether an existing association between CSI-RS ports and DMRS ports remains appropriate. A WTRU may indicate (e.g., in a beam failure recovery request message) whether a current association between CSI-RS ports and DMRS ports may be maintained.

An indication (e.g., about an association) may be explicit or implicit. TABLE 3 shows an example of an implicit indication, for example, where beam type=0 may imply (e.g., only) a control channel beam failure and beam type=1 may imply (e.g., only) a data channel beam failure. In an example, an association between a data channel and a control channel may not be maintained in these two cases. In an example of beam type 2 in TABLE 3, an association between a data channel and a control channel may be retained.

In an example, a beam failure recovery request message may contain an explicit indication (e.g., one bit), indicating whether a current association between a data channel and a control channel may be maintained.

A gNB may evaluate a beam dis-association recommendation that may be contained in a beam failure recovery request message from a WTRU. A gNB may inform a WTRU (e.g., in a beam failure recovery response message) about a decision whether an association between a data channel and a control channel may be maintained. In an example, a new association between a data channel and a control channel may be indicated (e.g., in a beam failure recovery response message).

TABLE 4 shows an example association between a data channel and a control channel. A table or other indication of association may be set up, for example, during a beam management at a gNB and a WTRU. In an example, a Tx data/channel association index may be applied for a data channel and a control channel. A disassociation between a data channel and a control channel may, for example, be based on a data/control association index, e.g., rather than on an explicit expression of CSI-RS ports or DMRS ports. In an example, a beam failure recovery request message may contain a Data/control association index, for example, to indicate that an associated data channel and control channel may not be maintained. A gNB may (e.g., in a beam failure recovery response message) use a data/control association index to indicate a new association between a data channel and a control channel.

TABLE 4

| Data/control | Data DMRS | Control CSI-RS |
|---|---|---|
| association index | port index | port index |
| 0 | 2 | 0 |
| 1 | 0 | 1 |
| 2 | 5 | 3 |

Systems, methods and instrumentalities have been disclosed for beam failure recovery. Beam failure detection may be based on one or more algorithms applying one or more thresholds to one or more (e.g., RSRP) measurements of one or more old, serving and/or candidate beams for one or more control channels and/or one or more data channels. Beam failure recovery request messaging may be based on different types of beam failures and/or prevailing beam information. Message transmission beams and directions may be based on beam conditions, UL/DL beam correspondence, and/or WTRU rotational state, which may lead to message transmission over candidate beams or omni-directional transmission. Beam information may be implied to reduce message overhead. Message response failures may lead to retransmissions with different power, beams, and/or direction(s). Multiple beam pair links may be monitored for individual and/or combined beam failures. Beam association between data and control channels may be managed during a beam failure recovery.

FIG. 14 is an example of a WTRU handling beam failure recovery request messages, e.g., as disclosed herein.

Features, elements and actions (e.g., processes and instrumentalities) are described by way of non-limiting examples. While examples may be directed to LTE, LTE-A, New Radio (NR) or 5G protocols, subject matter herein is applicable to other wireless communications, systems, services and protocols. Each feature, element, action or other aspect of the described subject matter, whether presented in figures or description, may be implemented alone or in any combination, including with other subject matter, whether known or unknown, in any order, regardless of examples presented herein.

A WTRU may refer to an identity of the physical device, or to the user's identity such as subscription related identities, e.g., MSISDN, SIP URI, etc. WTRU may refer to application-based identities, e.g., user names that may be used per application.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, terminal, base station, RNC, and/or any host computer.

1. A wireless transmit/receive unit (WTRU) comprising:
a memory; and
a processor, wherein the WTRU is configured to:
receive configuration information associated with beam failure recovery;
detect a beam failure and send a first beam failure recovery request message on a first beam to a network entity;
determine that a beam failure recovery response message has not been received using the configuration information associated with beam failure recovery; and
if the WTRU is associated with a static rotation state or a low rotation state, perform a per-beam based recovery; and
if the WTRU is associated with a high rotation state, perform an omni-directional beam recovery.

2. The WTRU of claim 1, wherein the WTRU is further configured to determine a rotation state and send an indication of the determined rotation state.

3. The WTRU of claim 1, wherein the configuration information associated with beam failure recovery includes one or more of a maximum number of beam failure recovery request messages and/or a timer.

4. The WTRU of claim 1, wherein the WTRU is associated with a static rotation state or a low rotation state and the first beam failure recovery request message was sent at a maximum power.

5. The WTRU of claim 4, wherein the per-beam based recovery comprises the WTRU sending a second beam failure recovery request message on a second beam.

6. The WTRU of claim 5, wherein the WTRU is further configured to, if a maximum number of beams have been used in the per-beam based recovery, send a third beam failure recovery request message, wherein the third beam failure recovery request message is sent over multiple beams simultaneously.

7. The WTRU of claim 1, wherein the WTRU is associated with a low rotation state, and wherein the WTRU is further configured to send a second beam failure recovery request message over multiple beams simultaneously.

8. The WTRU of claim 1, wherein the WTRU is further configured to, if a maximum number of non-omni-directional beam failure recovery request messages have been sent and the beam failure recovery response message has not been received, send a beam failure recovery request message on an omni-directional beam.

9. The WTRU of claim 1, wherein the WTRU is further configured to trigger a radio link failure when a maximum number of beam failure recovery request messages have been sent and the beam failure recovery response message has not been received.

10. The WTRU of claim 1, wherein the WTRU is further configured to trigger a radio link failure when the beam failure recovery response message has not been received by the expiration of a timer.

11. A method, comprising:
receiving, at a wireless transmit/receive unit (WTRU), configuration information associated with beam failure recovery;
detecting a beam failure and sending a first beam failure recovery request message on a first beam to a network entity;
determining that a beam failure recovery response message has not been received using the configuration information associated with beam failure recovery; and
if the WTRU is associated with a static rotation state or a low rotation state, performing a per-beam based recovery; and
if the WTRU is associated with a high rotation state, performing an omni-directional beam recovery.

12. The method of claim 11, further comprising determining a rotation state and sending an indication of the determined rotation state.

13. The method of claim 11, wherein the configuration information associated with beam failure recovery includes one or more of a maximum number of beam failure recovery request messages and/or a timer.

14. The method of claim 11, wherein the WTRU is associated with a static rotation state or a low rotation state and the first beam failure recovery request message was sent at a maximum power.

15. The method of claim 14, further comprising sending a second beam failure recovery request message on a second beam.

16. The method of claim 15, further comprising, if a maximum number of beams have been used in the per-beam based recovery, sending a third beam failure recovery request message, wherein the third beam failure recovery request message is sent over multiple beams simultaneously.

17. The method of claim 11, wherein the WTRU is associated with a low rotation state, further comprising sending a second beam failure recovery request message over multiple beams simultaneously.

18. The method of claim 11, further comprising, if a maximum number of non-omni-directional beam failure recovery request messages have been sent and the beam failure recovery response message has not been received, sending a beam failure recovery request message on an omni-directional beam.

19. The method of claim 11, further comprising triggering a radio link failure when a maximum number of beam failure recovery request messages have been sent and the beam failure recovery response message has not been received.

20. The method of claim 11, further comprising triggering a radio link failure when the beam failure recovery response message has not been received by the expiration of a timer.
